(19) United States
(12) Patent Application Publication
(10) Pub. No.: US 2016/0012396 A1
(43) Pub. Date: Jan. 14, 2016

(54) Coordinating communication on personnel issues

(71) Applicant: Judy A. Montoya, Albuquerque, NM (US)

(72) Inventor: Judy A. Montoya, Albuquerque, NM (US)

(21) Appl. No.: 14/326,226

(22) Filed: Jul. 8, 2014

(51) Int. Cl. G06Q 10/10; G06F 17/30; H04L 29/08

(52) U.S. Cl. CPC G06Q 10/105; H04L 67/10; G06F 17/30289

(57) ABSTRACT

The present invention creates a computer program that assists managers and supervisors of workers to document events and communications related to employment events which will enable managers to organize and standardize the process of providing progressive discipline, will improve work flow by automating the routing of electronic communications through the chain of command, will provide immediate access to written policies, employment contracts and union contracts that define or limit options for discipline, as well as assist the supervisor to educate the worker regarding policies to enable the worker to more successfully understand the expectations of the employing entity.

### STATEMENT REGARDING FEDERALLY SPONSORED R & D

None.

### NAMES OF PARTIES TO A JOINT RESEARCH AGREEMENT

None.

### CROSS REFERENCE TO RELATED APPLICATIONS

None.

### BACKGROUND OF THE INVENTION

1. Field of the Invention

The present invention creates a computer program that assists managers and supervisors of workers to document events and communications related to employment events which will enable managers to organize and standardize the process of providing progressive discipline, will improve work flow by automating the routing of electronic communications through the chain of command, will provide immediate access to written policies, employment contracts and union contracts that define or limit options for discipline, as well as assist the supervisor to educate the worker regarding policies to enable the worker to more successfully understand the expectations of the employing entity.

2. Description of the Prior Art

U.S. Patent Application Publication Number 20030083891 of Lang, Kenny W. et al., which was published on May 1, 2003 for Project Management Tool, describes a method and apparatus for the purpose of managing temporary personnel requirements. In one embodiment, the method comprises the steps of: listing a set of attributes for a plurality of tasks; acquiring a personnel data base of personnel skills/competences, wherein the personnel data base includes self-evaluations and factual information; using the factual information and the self-evaluations and picking individuals in the data base for inclusion into a pool of persons who are pre-qualified to perform at least some of the tasks; selecting a specific task and the attributes to perform the task; weighing the self-evaluated attributes of each of the individuals in the pool; and using at least the weighted self-evaluated attributes to match specific task attributes and identifying persons in the pool for hire.

The deficiencies of this reference are that the referenced application seeks to match skills of an employee with tasks needed by an employer in a temporary employment environment. The present application program provides a system to track worker discipline history, provide management with information related to discipline options, and will in addition provide management with report generating capabilities based on the compiled worker discipline history.

U.S. Patent Application Publication Number 20130191175 of Miller, Crichton et. al., which was published Jul. 25, 2013 for Haul It Nationwide Limited describes a personnel management system which includes a personnel activity recording terminal, a subscriber terminal for receiving subscriber assignments, a server for receiving data from the personnel activity recording terminal and the subscriber terminal, and a database for storing the data received at the server. The server is arranged to compare the data received from the personnel activity recording terminal and the subscriber assignments and to allocate assignments to personnel.

The deficiencies of this reference are that this program does not track disciplinary events related to workers from a Human Resource perspective. It is a system that is designed to match assignments to specific personnel rather than tracking events with specific personnel and providing management with tools and communication systems to monitor the workers' histories and trends regarding violation of employer policies.

U.S. Pat. No. 8,725,548 of Leitch; Matthew et. al., dated May 13, 2014 describes a dynamic approval system, capable of integration with enterprise software systems, where approval requests are generated from within application programs and processed using one or more dynamic approval rules comprising discrete rule steps and step criteria. For each approval request, only those rule steps applicable to the requestor and type of request are processed. Individual rule steps may be reordered, added or skipped, as appropriate, during an approval process. Typical rule steps include at least one request for approval or review. The party receiving the request may be a specific individual, a person holding a specific position, or a person having a relative relationship, such as supervisor, with the requestor.

The deficiencies of this reference are that this program is limited to approval of generic requests between managers. The patent does not use the process to track disciplinary events related to workers from a Human Resource perspective. The program which is the subject of the present patent application tracks events with specific personnel and provides management with tools and communication systems to monitor the workers' histories and trends regarding violation of employer policies.

U.S. Patent Application Publication Number 20080262883 of Weiss; Stephen J. et al. which was published Oct. 23, 2008 describes systems and methods for compliance and announcement display and notification.

The deficiencies in this reference are that the referenced application only maintains compliance documents and makes them available. While the present application maintains a database of employment policies, employment contracts and other Regulation Source Information, the present application program makes the Regulation Source Inform available to managers at a time when that source information is relevant to a decision to be made by managers. The present application program goes much further by providing an organized way to track events and worker discipline histories in a way that allows managers to see trends that will help in further developing employment policies as well as determining appropriate progressive discipline and providing reports or other information to assist with employment disputes.

U.S. Patent Application Publication Number 20140067448 of Joshi, Arushi Sood, et. al., which was published Mar. 6, 2014 for Unidash, Inc. describes a system and method for a continuous event and incident management approach to regulatory and compliance management, and business process management.

The deficiencies in this reference are that the referenced application does not track worker discipline history and provide communication tracks for management to review notices as they are created and does not provide a method for managers to have access to Regulation Source Information relevant to the incident being documented and reviewed.

### SUMMARY OF THE INVENTION

The present invention is a computer program that organizes data in databases and provides for the interaction of those various databases in a way that gives supervisors and their managers the ability to track employment events that might require discipline of various types of the numerous workers employed by an entity. The program gives managers the ability to view source information created by various methods including laws, rules or regulations, written policies, contracts and union agreements, that will assist managers in determining appropriate action in response to various employment related events of the employing entities workers. The program also keeps forms used in creating notices to workers in a data base and allows management to use the forms and modify certain portions of the forms as appropriate for the unique facts in any situation. The program has the ability to allow operators with appropriate authority to input and modify the source documents in the databases where the documents are stored.

In addition to providing an organized method of documenting events and tracking the process from beginning to end, the program also allows management personnel to use the collected data to generate reports that will be useful to management in determining whether workers are in need of additional training to reduce violations of the company policies.

The history tracking portion of the data base will also be useful to management in the event legal actions are initiated by workers. Employers will have the ability to show the steps taken in progressive discipline.

An object of the invention is to improve communications between management individuals in the chain of command for each of numerous workers by automating the communication path up the chain of command when notices are created with higher level management given the ability to approve or disapprove specific recommendations or notices made by or drafted by lower level management.

### BRIEF DESCRIPTION OF THE DRAWINGS

FIG. 1. is a flow chart of process prior to discipline.

FIGS. 2A and 2B combine into a 2 page flow chart of the process and the process related to discipline.

FIG. 3. is a flow chart of the process related to appeals.

### DETAILED DESCRIPTION OF THE INVENTION

### 1. Definitions

Approved Administrative Access: as used herein in Claim 5 means access given to only those individuals who have authority to determine, create, modify or approve the employment policies of the employing entity together with those employees authorized to actually make the required entry, deletion or modification of the Regulation Source Information in the data base.

Database Management System: as used herein means a manner of keeping Regulation Source Information, Worker Identification information, and Worker discipline information that can be accessed by providing a manager a drop down menu in the manager may select Regulation Source Information which the manager may find useful for discipline or training purposes.

Regulation Source Information: as used herein means written or electronic documents that regulate or define acceptable or unacceptable worker behavior including but not limited to written or electronic employment policies, regulations, laws, employment contracts, and union agreements that managers of the employing entity need to be familiar with when making decisions regarding discipline of workers.

Selected Identification Information of Workers: as used herein means the identification information which the employer has determined shall be used to identify workers in the data base and which will not necessarily contain social security information or even complete legal names if employer wishes to protect worker identification information.

Worker: As used herein the word “worker” means any employee, independent contractor or volunteer worker that the employing entity may wish to monitor for continuation of employment, training or discipline purposes.

### 2. Best Mode of the Invention

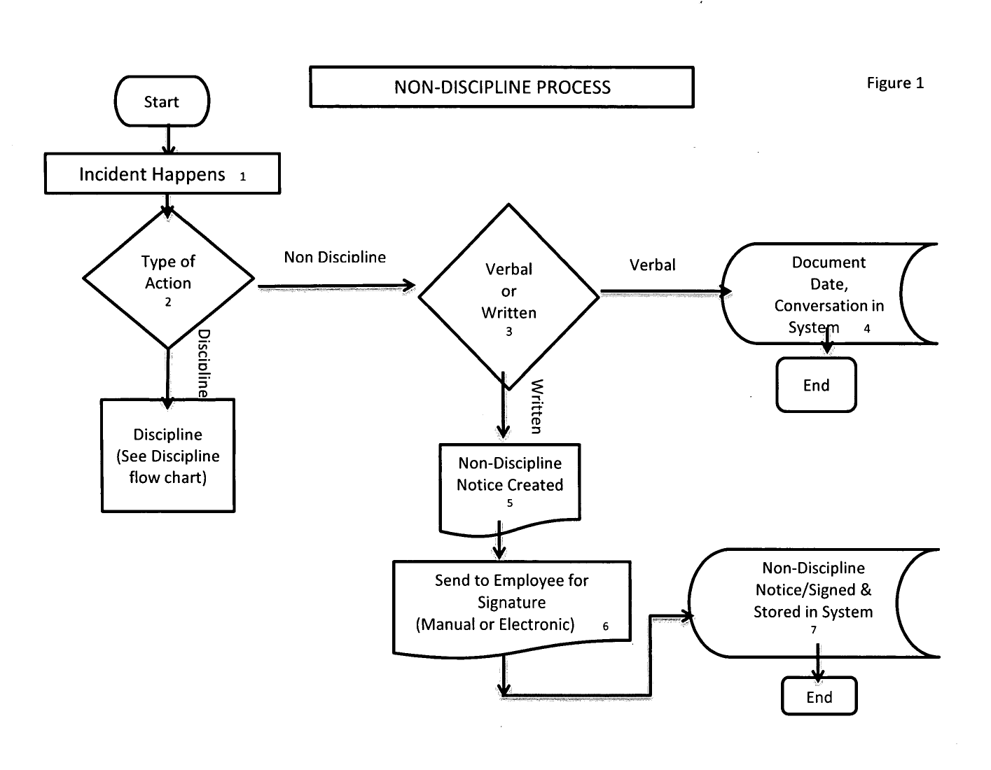

The best mode of the invention, as shown in FIGS. 1, 2A, 2B and 3 as shown and described. This program can be installed on local servers but in the best mode will be run and accessed in secure remote servers commonly referred to as cloud servers. The program also has the ability to limit the direction of communication between managers to force the analysis to move forward toward resolution. This patent extends to any use of the software as contained in the claims whether or not the customer who purchases the program wants to modify the communication restrictions that are available in the best mode of the program.

In best mode this program allows a worker's immediate and higher level managers to enter information into a form provided which information is related to the employment history of the worker as events occur or are reported in which the worker is alleged to have violated some policy, regulation or law. The program provides managers with immediate access to Regulation Source Information which is related to the alleged violation and may assist the managers in the chain of command to determine the best course of action to prevent future violations; these possible courses of action could include anything from training to termination of employment.

### 3. How to Make the Invention

The drawings are flow charts that establish the process of the program from the occurrence of an incident that might be a violation of company policy, regulation or law through the creation and modification of notices, delivery of notices to workers, and the communication between managers. The flow charts document the initial non disciplinary process, the disciplinary process prior to dispute resolution and then dispute resolution that may include use of alternative dispute resolution or legal dispute resolution. The program must be assembled in a manner that is consistent with the flow charts in FIGS. 1, 2A, 2B, and 3.

FIG. 1 establishes the decision process when an incident takes place and the manager or supervisor is given the ability to enter a description of the incident and make the first decision regarding whether disciplinary action is necessary to address the event or whether a verbal or written documentation of discussions is sufficient.

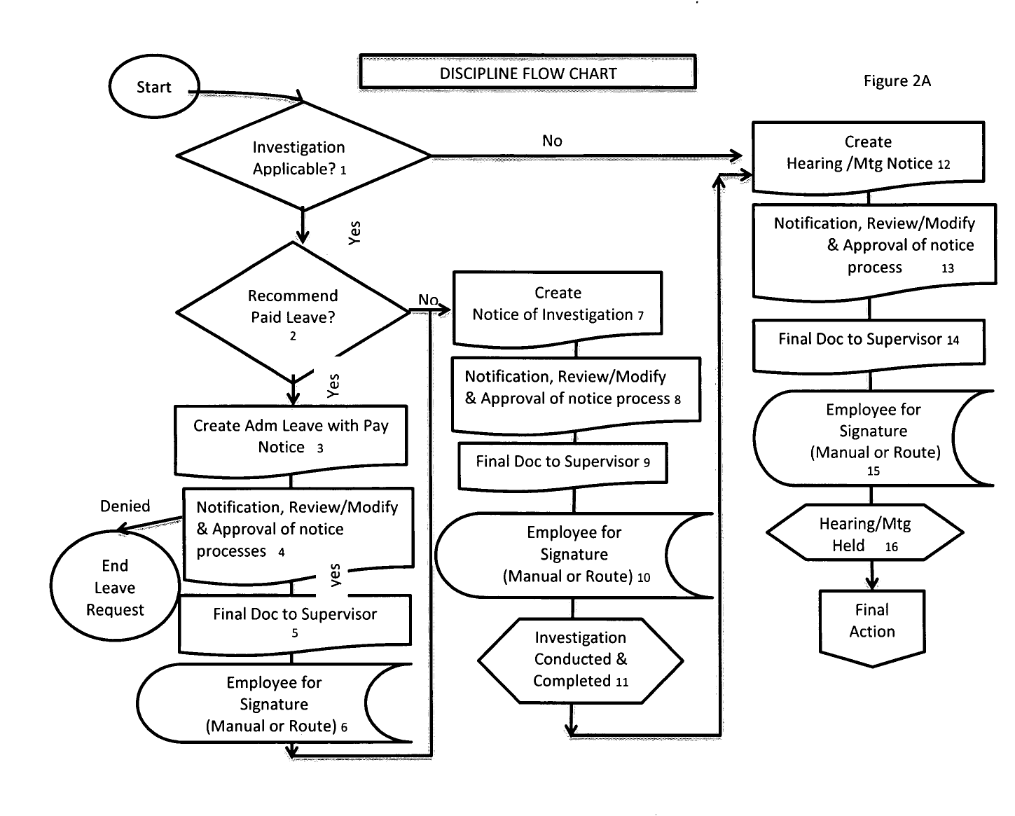

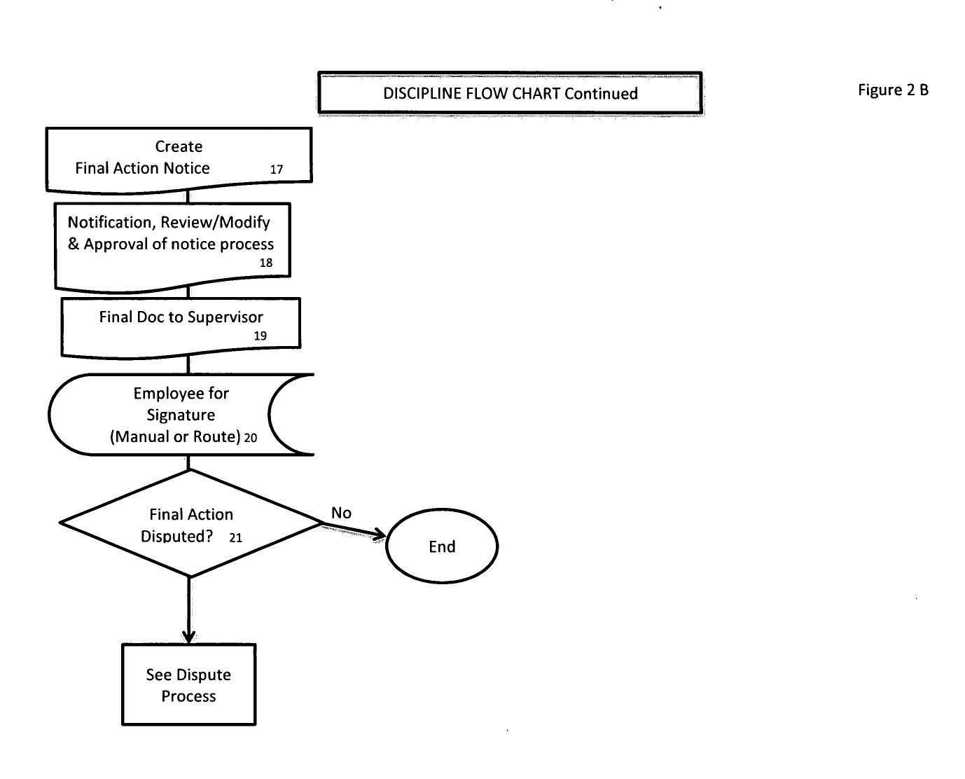

FIGS. 2A and 2B reflect how the program provides management with the ability to generate notices for the progressive discipline process, including investigations, paid leave notice, hearing or meeting notice, and documenting the results through the final action notice as shown in FIG. 2B.

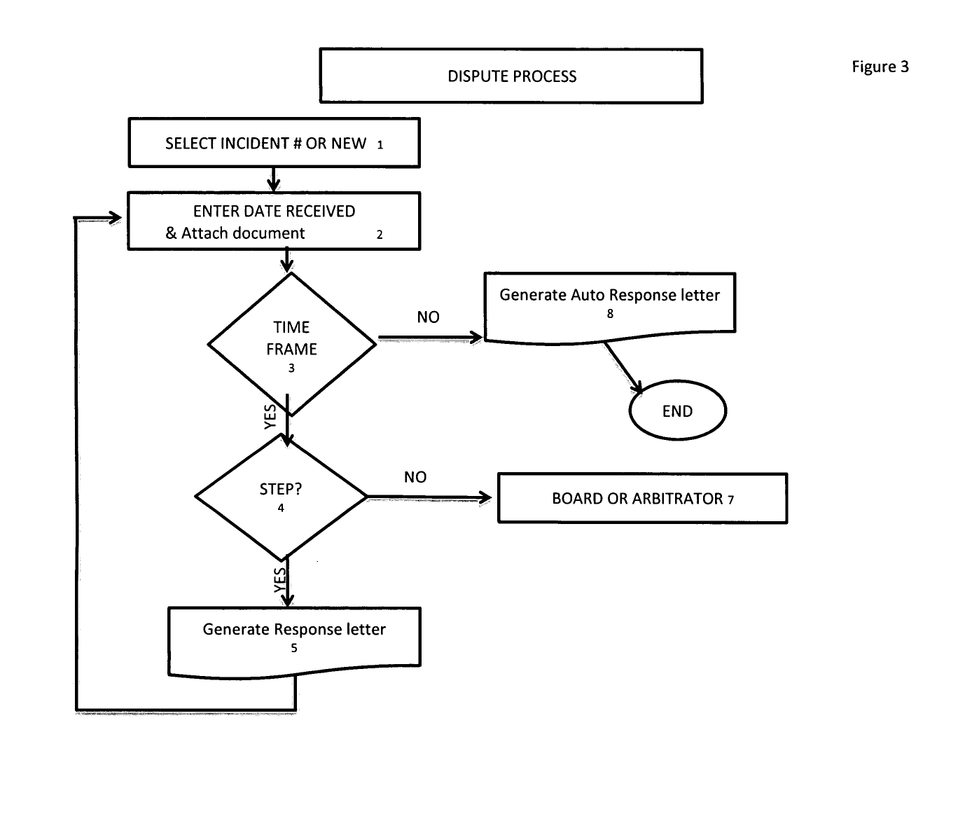

FIG. 3 reflects the process for conducting an appeal in the event the final action determined in FIG. 2B is disputed by the worker and incorporates disputes within the organization in addition to disciplinary disputes.

### 4. How to Use the Invention

This is a program that coordinates communications on personnel issues by using computer systems including servers and work stations. The management employees are trained to use the software program. The process includes learning to input the data using computer systems with access to the program. The system gives management user friendly screens with drop down menus that allow managers to see policies, regulations, laws and contract terms that are kept in a database on the server.

The server keeps information in several data bases that are accessible through the computer screens of each manager for whom the employer has purchased a license. The communication between the servers and the managers' computers is designed to both allow managers to input incident information and to retrieve information from the databases in a bi-direction manner. The database information will include Regulation Source Information which govern the discipline and training options available to management when addressing any one of the workers employed by the employer. The data base will also include disciplinary history of each employee and also selected identification information for each worker. The selected information does not need to be more extensive than necessary to identify the worker for purposes of the program. Full identification information can be included or can be protected by not being included.

Once event information is documented then that information may be recalled by management in helping the process of determining the appropriate training or discipline which should be used for the worker.

The Regulation Source Information will change from one employer to another and from one year to another for any given employer who has purchased the program. The program has the ability to insert new Regulation Source Information to set up the system when initially purchased as well as for situations when the employer adopts new policies or when new regulations or contracts dictate a change in policy. The system also allows employers to include the effective dates of the Regulation Source Information so that management can ensure that the Regulation Source Information in the data base is kept current.

The program contains an additional database that stores forms to be used for creating notices to be given to workers. The notice forms have sections in which the managers are able to insert information related to the specific event which has been documented. There are other sections of the form which contain legal or other specific language that is required to be in the notice and cannot be modified by anyone other than those individuals with Approved Administrative Access. These will be high level management who will be working with their legal counsel or human resource management individuals. This will protect the integrity of the form and reduce the risk that the notice will fail to contain critical information which is necessary in the event of future legal disputes.

The communication portion of the program also provides notification when a task to be performed is pending such as approving a notice or when a time deadline is approaching. The communication portion of the program also directs the flow of the work to ensure that delays are not created by the process being returned to lower level individuals once the event has moved through the approval process until the final approval regarding recommended action or final notice has been approved. Once approval is granted by management in the chain of command immediate supervisors are notified and are authorized to given the approved notice to the worker or implement the approved action with the worker.

The notices that are initially selected and modified by immediate supervisors are routed by the communication portions of the program to upper management in the chain of command with upper level management being given the opportunity to approve or modify the portions of the notice that may be modified without Approved Administrative Access. The program will also document receipt of notices by workers. The same communications provisions allow upper management to review and modify discipline suggestions of lower management.

Each documented event is then kept in the appropriate database in order to allow management to view the disciplinary history of workers in the future. This history will include the fact that events took place, whether disputes arose, time frames of the past events, notifications that were provided to the workers, the status of disputes and disciplinary actions and the final results. This reporting capability is available for export into outside spreadsheet software.

The program contains calendar capabilities which are used to remind managers of deadlines associated with disciplinary action as required by employment policies, union contracts or other Regulation Source Information.

The communication provisions in the program use email communications from out of program email systems to inform management that a new notice or action is pending.

The program allows the managers to collect data over time which is then available to management to document that they have provided progressive discipline. That same data also allows management to track and understand trends which enable management to make critical decisions concerning training and organizational development.

The patent is not limited by the specifications or the other parts of the application. The scope of the application is limited only by the claims.

1. A system for coordinating communications on personnel issues comprising: a server in a remote and secure environment plus a plurality of computer systems coupled to said server via bi-directional communication links.

2. The system of claim 1, further comprising: a database management system coupled to said server for storing a plurality of employment policies.

3. The system of claim 1, further comprising: a database which can be modified to insert or amend employment policies and include the effective dates.

4. A system of claim 1, further comprising: a database management system coupled to said server for storing a plurality of notices to be selected for informing workers of disciplinary action selected by management.

5. A system of claim 1, further comprising: a set of notices that can be interactively modified by management personnel through the approval process which contain certain legal language which may be modified only by individuals with approved administrative access.

6. A system of claim 1, further comprising: a database management system coupled to said workflow management server for storing a plurality of selected identification information of workers.

7. A system of claim 1, further comprising: a database management system coupled to said workflow management server for storing the disciplinary history of a plurality of workers.

8. A system of claim 1, further comprising: a database management system coupled to said workflow management server for tracking employment disputes, including timeframes, notifications, status and results.

9. A system of claim 1, further comprising: a calendar system that reminds management personnel of deadlines associated with disciplinary action as required by employment policies and union and/or employment contracts.

10. A system of claim 1, further comprising: a communication system compatible with the computer systems and the workflow management server.

11. A method of collecting data regarding discipline of workers the method comprising the steps of: providing supervisors with an electronic form in which to document the discipline related activities of a worker; with access to a data base of relevant personnel policies that apply to the appropriate disciplinary steps.

12. A method according to claim 11, further comprising the step of: notifying management personnel in the chain of command of the events and providing those management individuals with access to written policies and deadlines associated with the events documented.

13. A method according to claim 11, further comprising the step of: documenting receipt of disciplinary related communications by management personnel and receipt of notices by workers.

14. A method according to claim 11, further comprising the step of: notifying the supervisor and management personnel in the chain of command of appropriate discipline options based on the events documented and the discipline history of the worker involved.

15. A method according to claim 11, further comprising the step of: informing the upper management personnel in the chain of command of recommendations for discipline made by lower management personnel in the chain of command and providing upper management personnel in the chain of command with the option of approving or overriding lower management recommendations.

16. A method according to claim 11, further comprising the step of: documenting receipt of the report of events related to needed disciplinary actions by management personnel and tracking the events and communications of supervisors and management personnel regarding those events.

17. A method according to claim 11, further comprising the step of: providing a communication route for upper management approval of proposed disciplinary action selected by lower management personnel.

18. A method according to claim 11, further comprising the step of: providing management with the ability to track communications made with workers regarding clarifications of company policies to assist workers to more successfully meet the expectations of the employing entity.

19. A method according to claim 11, further comprising the step of: providing management with the ability to track progressive discipline provided to workers.

20. A method according to claim 11, further comprising the step of: tracking and reporting on the creation, status and results of employment disputes between workers and management.

21. A method of generating reports comprising the steps of: compiling the historical data regarding employment policies violated, investigations in progress, grievances pending, past grievance results, based on management selection and exportable to spreadsheet software.
